(19) United States
(12) Patent Application Publication
(10) Pub. No.: US 2024/0176591 A1
(43) Pub. Date: May 30, 2024

(54) RANDOM NUMBERS BY ABELIAN VARIETIES

(71) Applicant: Xephor Solutions GmbH, Purkersdorf (AT)

(72) Inventor: Konstantin Oppl, Purkersdorf (AT)

(21) Appl. No.: 18/411,877

(22) Filed: Jan. 12, 2024

Related U.S. Application Data
(63) Continuation of application No. PCT/AT21/60252, filed on Jul. 16, 2021.

(51) Int. Cl. G06F 7/58

(52) U.S. Cl. CPC G06F 7/58

(57) ABSTRACT

A computer-implemented method for generating at least one random number includes determining at least one measured seed value with a sensor based on the at least one measured seed value, determining a set of selecting functions, where a selecting function maps onto a point on an Abelian variety; evaluating the selecting functions in order to obtain a set of starting points on the Abelian variety; generating a set of output points on the Abelian variety by applying the group operation of the Abelian variety to at least one of the elements of the set of starting points; and extracting at least one random number from the set of output points.

### TECHNICAL FIELD

The present invention relates to the field of random number generation from measured seed values by using group structures on Abelian varieties like elliptic curves or hyper-elliptic curves.

### BACKGROUND

Random numbers are a basic ingredient for many types of simulations used in many different industrial and scientific branches, from economy to physics and from data science to computer games. More specifically, random numbers might be necessary for running artificial intelligence algorithms, especially comprising neural networks, or for running Monte-Carlo simulations, for example for solving stochastic differential equations. Moreover, random numbers are used for various cryptographic purposes, for instance the creation of random keys for encrypting messages.

Pseudo-random number generators (PRNG) are implemented in software of a digital computer, and deliver sequences of pseudo-random numbers simply and efficiently. However, they are intrinsically deterministic and care has to be taken that the sequence of pseudo-random numbers is not repeating, i.e. that the period of the sequence is large enough. For cryptographic purposes it is moreover important that the sequence is not predictable.

Many PRNGs are known from literature. Simple linear congruential generators are known to deliver poor quality random number sequences with very low periods of randomness. Existing PRNG with large periods like the Mersenne-Twister PRNG overcome some problems, but still implementation-specific correlations can be found in the resulting random sequences.

The book ‘Handbook of elliptic and hyperelliptic curve cryptography’ (Chapman & Hall, 2006) by Henri Cohen and Gerhard Frey discloses the use of Abelian varieties like elliptic curves or hyper-elliptic curves as building blocks for PRNGs. Abelian varieties provide an Abelian group structure and are well-studied in the context of cryptography. Hence using Abelian varieties as building blocks for PRNG, a person skilled in the art gains flexibility and can make use of a profound theoretical background framework.

An algebraic variety is an object which can be described by polynomial equations set to zero. A special form are projective varieties, which also contain the point at infinity. Further, a special form of projective varieties are Abelian varieties, which exhibit the structure of an Abelian group and the structure of algebraic varieties. The elements of an Abelian variety are thus solutions of polynomial equation systems, wherein the solutions are called ‘points’ in the following. The points can be added by a group operation, such that added points are again points in the Abelian variety again.

An example of an Abelian variety are elliptic curves ε over a field L, where the point at infinity P_{≈} is included. These can sometimes be given by the Weierstrass equation y²=X³+ax+b, where a and b are parameters. The Abelian group defined by the elliptic curve contains all points on the curve and an addition ⊕ as group operation. In typical implementations on computers, the field L is a finite Galois field. Especially, the field L over which the Abelian variety is defined can be a prime field or an extension field over a prime field.

Since the output points obtained by adding points with the group operation are quite unpredictable, the addition of points on an Abelian variety can be used to create pseudo-random numbers.

True random number generators (TRNG) make use of random physical processes to determine a non-deterministic sequence of random numbers, a well-known example being a sequence of coin tosses. Digital computers offer random processes as the noise generated by an electric component, temperature, user mouse movement or clock ticks, for example, which can be measured by a plurality of sensors.

However, the amount of randomness of the measured sequence depends on the fluctuation of the truly random process. For instance, the temperature of a well-cooled CPU might not vary much, creating a sequence of similar temperatures. To quantify the uncertainty and thus the randomness, the entropy, for instance the Shannon entropy, is often used as a measure. In the following ‘amount of randomness’, ‘randomness’ and ‘entropy’ are used interchangeably, although other measures of the amount of randomness than entropy are thinkable.

To overcome some disadvantages of TRNGs and PRNGs, both may be combined, for instance by seeding a PRNG with the measured seed values from sensors of a computer. The U.S. Pat. No. 8,396,213 B2 describes a variation of DUAL_EC_DRBG, a PRNG based on the addition of points on an elliptic curve, where initially a point is chosen based on a random measured seed value.

The Fortuna random number generator as described in ‘Cryptography Engineering’, Chapter 9 (Wiley Publishing, 2010) by Niels Ferguson, Bruce Schneier and Tadayoshi Kohno discloses reseeding of a PRNG, where an entropy accumulator pools measured seed values (i.e. entropy) from various sensors, combines the measured seed values with a hash function and reseeds the PRNG in a periodic manner.

It is desirable, that individual measured seed values are combined such that the resulting random number has an enhanced randomness, especially with respect to the individual measured seed values, while the performance of random number generation is enhanced.

### SUMMARY OF THE INVENTION

It is a task of the present invention to process truly random measured values from sensors in order to obtain at least one random number with enhanced randomness efficiently.

The task is solved by a computer-implemented method according to claim 1, a random number generating device according to claim 13 and a computer program according to claim 15.

A computer-implemented method according to the invention comprises the following steps:
determining at least one measured seed value with at least one sensor
based on the at least one measured seed value, determining a set of selecting functions, where a selecting function maps onto a point on an Abelian variety
evaluate the selecting functions in order to obtain a set of starting points on the Abelian variety
generating a set of output points on the Abelian variety by applying the group operation of the Abelian variety to at least one of the elements of the set of starting points
extracting at least one random number from the set of output points

A random number generating device according to the invention comprises
at least one sensor,
a function unit,
a selection unit,
an arithmetic unit,
an extraction unit,
   where
the at least one sensor is operable to determine at least one measured seed value,
the function unit is operable to determine a set of selecting functions based on the at least one measured seed value, where a selecting function maps onto a point on an Abelian variety,
the selection unit is operable to evaluate the selecting functions in order to obtain a set of starting points on the Abelian variety,
the arithmetic unit is operable to generate a set of output points on the Abelian variety by applying the group operation of the Abelian variety to at least one of the elements of the set of starting points,
the extraction unit is operable to extract at least one random number from the set of output points.

A computer program according to the invention causes the random number generating device to be configured as described or to carry out the computer-implementable method as described, when the program is executed by a random number generating device.

The application of the group operation to the starting points, which were randomly selected with the set of selecting functions, yields hard-to-predict random output points, which are further used to extract the at least one random number. Thus the truly random measured values from sensors are processed such that the randomness of the resulting at least one random number is enhanced.

The set of selecting functions based on the at least one measured seed value acts like a set of random filters selecting points on the Abelian variety. Preferably the selecting functions are configured such that they map to starting points on the Abelian variety which are heterogeneous with respect to the group structure of the Abelian variety. ‘Points which are heterogeneous with respect to the group structure’ might for instance mean, that the points tend to be part of many different subgroups, especially that they are not within the same cyclic subgroup of the Abelian variety. By that, it is avoided that predictable results are obtained when the group operation is applied to the points.

### DESCRIPTION OF EMBODIMENTS

In a preferred embodiment of the invention the at least one measured seed value is a physical quantity such as a temperature or the noise of an electronic component, the time signature of an event such as a user input, a clock tick, a value describing network traffic and/or a value describing memory access.

Further, the at least one measured value can be measured by at least one sensor placed in the hardware of the computer, especially in the network interface card and/or in the central processing unit.

The at least one measured value can be obtained from commands depending in the operating system. Two examples are given for the Solaris operating system and an Oracle SPARC CPU: measurements of a binary data stream, comprising Ethernet and/or the Internet Protocol, can be obtained with the snoop command, for instance snoop −v −d igb0. Measurements of the temperature, preferably stemming from more than 256 different sensors placed for instance in the central processing unit and/or the memory, can be obtained with the prtpicl command, for instance prtpicl −v −c temperature-sensor.

Typically, the at least one measured value is represented by a bit string, preferably a bit string with a length of 64 to 16000 bits.

In a preferred embodiment of the invention, the at least one selecting function is a continuous and/or non-linear function of a selecting input, wherein it is preferred that the selecting input is represented by a matrix. The selecting input might for instance be an element of the Galois group of the field over which the Abelian variety is defined, that is, an automorphism of the field. By this, information about properties of the field, for instance a Galois field, may be included in the process of obtaining starting points on the Abelian variety. An element of the Galois group can be represented by a matrix on the field over which the Abelian variety is defined.

In a further preferred embodiment, the at least one selecting function is obtained by choosing a model function with at least one first parameter and at least one second parameter, wherein the computer-implemented method comprises the following steps:
select at least one first parameter of a model function based on the at least one measured seed value,
select at least one second parameter of the model function such that the model function maps a selecting input, preferably represented by a matrix, to the Abelian variety,
obtain the selecting function by identifying it with the so-fitted model function and/or by combining the so-fitted model function evaluated with at least one, preferably at least two different, selecting input(s).

By this selecting functions can be obtained which are based on at least one measured seed value and which map a selecting input to the Abelian variety. In order to find the at least one second parameter, methods from linear algebra, especially Gröbner bases, can be used.

The expressions ‘fitted model function’ and ‘so-fitted model function’ denote a model function which maps onto the Abelian variety.

In the last step, the fitted model function which already points onto the Abelian variety can for instance be combined with one of the following operations: addition, subtraction, multiplication with a scalar and/or modulo operation. The fitted model function can for instance be evaluated with different selecting inputs, where each evaluation yields a point on the Abelian variety. The yielded points might be added or subtracted with each other or multiplied with a matrix or a scalar, or a modulo operation can be applied.

In an especially preferred embodiment of the invention, the selecting functions are elements of at least one cohomology group of the Abelian variety, preferably wherein the at least one cohomology group is defined by methods from Galois cohomology based on the field over which the Abelian variety is defined. In particular, the fitted model functions can be combined such that the resulting selecting function corresponds to an element of at least one cohomology group.

The use of cohomological calculations for determining selecting functions provides a systematic way of finding starting points on the Abelian variety which are heterogeneous with respect to the group structure of the Abelian variety. By that the application of the group operation to the starting points yields even more random output points.

Alternatively or additionally, the selecting functions can correspond to elements of a structure derived from at least one cohomology group of the Abelian variety, preferably wherein the structure derived from the at least one cohomology group of the Abelian variety is defined from duality and/or bilinear forms.

In a preferred embodiment the at least one cohomology group is
a first-order cohomology group, wherein a selecting function preferably takes at least one, preferably two, element(s) of the Galois group of the field on which the Abelian variety is defined as input, and/or
a second-order cohomology group, wherein a selecting function preferably takes a at least one, preferably three, element(s) of the Galois group of the field on which the Abelian variety is defined as input, and/or
a cohomology group with an order higher than two.

The use of cohomological calculations for determining selecting functions provides a systematic hierarchy of complexity and thus randomness of the resulting random number. If efficiency is demanded, elements of low-order cohomological groups, such as the first-order cohomology group, can be used as selecting functions. If more randomness is needed, elements of higher-order cohomological groups, such as the second-order cohomology group or even higher-order, can be used as selecting functions, typically accompanied by the cost of a reduced efficiency.

It can be intended that the at least one selecting function is obtained by choosing a model function with at least one first parameter and at least one second parameter, wherein the computer-implemented method comprises the following steps:
select at least one first parameter of a model function based on the at least one measured seed value,
select at least one second parameter of the model function such that the model function maps a selecting input, preferably represented by a matrix, to the Abelian variety
obtain the selecting function by combining the so-fitted model function evaluated at different selecting inputs such that it corresponds to an element of the at least one cohomology group, preferably whereby the combination comprises a part corresponding to a cocycle function modulo a part corresponding to a coboundary function.

Thus a selecting function which is based on the at least one measured seed value and which corresponds to an element of at least one cohomology group can be obtained numerically.

Cocycles are functions mapping onto the Abelian variety which are in the kernel of a differential operator. Coboundaries are functions mapping onto the Abelian variety which are in the image of a further differential operator. These expressions and cohomology theory are known from state of the art. Fitted model functions may be combined such that they correspond a coboundary function or a cocycle function, respectively.

In a preferred embodiment, a starting point is generated by evaluating a selecting function with a selecting input, wherein the selecting input is preferably
an element of the Galois group of the field over which the Abelian variety is defined and/or,
represented as a matrix.

Several different selecting inputs, for instance different elements of the Galois group of the field over which the Abelian variety is defined, can be used to obtain several input points on the Abelian variety. But also a single selecting input can be used to obtain several input points with different selecting functions. Finally, in a preferred embodiment several fitted model functions evaluated at different selecting inputs, for instance with different elements of the Galois group, can be combined in order to obtain a selecting function. The selecting input might then correspond to at least two elements of a Galois group.

In a further embodiment, a recursion is applied in order to obtain a set of starting points, wherein the recursion comprises the following steps
evaluate the selecting function with at least one selecting input in order to obtain a point on the Abelian variety
change at least one parameter of the selecting function based on the previously obtained point on the Abelian variety
repeat the previous steps with the updated selecting function.

Preferably the selecting function comprises a point on the Abelian variety as a parameter and this parameter is substituted with the point on the Abelian variety obtained in the previous step of the recursion. The selecting function with the new parameter is evaluated again, and so on in a recursive way. Thereby, several starting points can be obtained in a systematic way.

By using a recursion with well defined properties, several starting points on the Abelian variety can be obtained in a systematic and efficient way.

In a preferred embodiment, the recursion is run through for a number of iterations, yielding a starting point in each step. After the number of iterations, a new set of selecting functions is determined based on the at least one measured seed value. Preferably, the number of iterations is fixed and/or depends on the outcome of the iterations, for instance on at least one starting point. The number of iterations might as well be based on at least one measured seed value.

At least one cocycle function and/or at least one coboundary function can be chosen randomly. To this end, a trial and error method can be applied. A trial and error method is preferably applied when cohomology groups of an order higher than first-order are used as a base for the selecting functions.

The elements of the Galois group of the field over which the Abelian variety is defined, which are used as selecting input, can be chosen randomly, preferably based on at least one measured seed value. If the element are represented by a matrix, at least one matrix element can be chosen randomly, preferably based on at least one measured seed value.

In a preferred embodiment, a set of output points is generated by calculating the sum of the elements of at least one subset of the set of starting points with the group operation to obtain one output point per subset. By this addition, a pseudorandom step is performed, yielding one or several hard-to-predict output points. Especially, the randomness of several measured seed values can be combined to obtain few or even a single output point on the Abelian variety.

Preferably, the sum of all elements of the set of starting points is calculated with the group operation to obtain one output point. By this, several individual measured seed values are combined to obtain one random output point on the Abelian variety. By this the randomness is condensed into a single point.

In an alternative or additional embodiment, a set of output points is generated by adding at least one element of the set of starting points to itself, preferably by applying a linear congruential scheme, a power generator scheme or a Naor-Reingold scheme on the Abelian variety. In this way, a pseudo-random sequence of output points can be obtained.

In a preferred embodiment, the at least one random number is extracted from the set of output points by
taking a coordinate of at least one output point, and/or
applying a trace function, where preferably a trace function is applied to a coordinate of at least one output point, and/or
applying an integerization function, where the integerization function has an integer output, where the integerization function is in particular a floor function or a ceiling function.

Applying the trace function further sums up much information to less information an thus increases the randomness of the result.

In particular, it might be intended that first a coordinate of the at least one outpoint is chosen. For an elliptic curve, this would correspond to choosing the x- or the y-coordinate. This step can result in obtaining a bit string of some length.

Applying the trace to this result can lead to a shorter bit string of some shorter length. Especially, the bit string might be reduced to one bit. For instance, one might apply a trace to reduce an element of an extension field to an element of a prime field.

Alternatively, when working with float numbers, an integerization function might be used in order to obtain an integer as random output.

In a preferred embodiment, the computer comprises at least one processing unit running at least one process, wherein a process comprises at least one thread. At least one of the steps of the computer-implemented method is run by a dedicated thread, wherein the dedicated threads interact via asynchronous parallelization, preferably by using semaphor and/or a shared memory which can be accessed by at least two dedicated threads. Also, mutex methods can be used to coordinate access to shared data.

By asynchronous parallelization, tasks can be executed as soon as the necessary data is deposed in the shared memory by a previous task. By this, the different tasks can be calculated efficiently.

In a further embodiment
a first dedicated thread calculates cocycle functions, and/or
a second dedicated thread calculates a function corresponding to a cocycle modulo a coboundary, and/or
a third dedicated thread evaluates the selecting functions, and/or
a fourth dedicated thread adds starting points on the Abelian variety.

The first and the second dedicated threads create selecting functions. The third dedicated thread evaluates the selecting functions to obtain starting points on the Abelian variety. The fourth dedicated thread performs the group operation on the starting points in order to obtain at least one output point. A further dedicated thread could perform the trace on the at least one output point.

A preferred embodiment of the random number generating device comprises at least one processing unit operable to run at least one process, wherein a process comprises at least one thread, wherein
the function unit comprises at least one function thread, and/or
the selection unit comprises at least one selection thread, and/or
the arithmetic unit comprises at least one arithmetic thread, and/or
the extraction unit comprises at least one extraction thread,
   wherein the threads interact via asynchronous parallelization, preferably by using semaphors and/or a shared memory which can be accessed by at least two threads.

As mentioned above,
the function unit is operable to determine a set of selecting functions based on the at least one measured seed value, where a selecting function maps onto a point on an Abelian variety,
the selection unit is operable to evaluate the selecting functions in order to obtain a set of starting points on the Abelian variety,
the arithmetic unit is operable to generate a set of output points on the Abelian variety by applying the group operation of the Abelian variety to at least one of the elements of the set of starting points,
the extraction unit is operable to extract at least one random number from the set of output points.

For instance, the at least one function thread might comprise a thread calculating cocycle functions and a thread calculating functions corresponding to a cocycle modulo a coboundary.

A further embodiment of the random number generating device is operable to carry out the above described computer-implementable method including its embodiments.

In the following, some above-mentioned mathematical concepts are described for a person skilled in the art. In the above-described computer-implemented method, the random number generating device and the computer program, some mathematical concepts are implemented on a computer. The mathematical concepts might only be implemented approximately. For details, it is referred to the book ‘Handbook of elliptic and hyperelliptic curve cryptography’ (Chapman & Hall, 2006) by Henri Cohen and Gerhard Frey.

The Abelian variety [symbol] can be an elliptic curve [symbol] and/or a hyperelliptic curve [symbol] [symbol] . Elliptic curves and hyperelliptic curves are known to comprise an Abelian group structure and are well studied, particularly in the context of cryptography. Hence there is a well-developed theoretical background and arithmetic units for fast group operations on elliptic curves are available. The computer-implementation of the addition of points on an Abelian variety can be done with state-of-the-art methods.

The Abelian variety [symbol] can be defined over a quotient field L, where said quotient field is a Galois field. Galois fields are finite and thus straightforwardly implementable on computers. Again, being a usual choice in cryptography, Abelian varieties over Galois fields are well-studied.

The order q of a Galois field is constricted to powers of a prime p, i.e. q=p^{d}. The Galois field [symbol] (q) of order q=p^{d} is said to have the dimension d and creates a d-dimensional vector space. It is defined as the quotient field [symbol] (q)= [symbol] (p)[X]/P of the polynomial ring [symbol] (p)[X] by the ideal generated by the irreducible polynomial P in [symbol] (p) of degree d. The elements of [symbol] (q) are polynomials over [symbol] (p) whose degree is strictly less than d and the addition and the subtraction are those of polynomials over [symbol] (p). The product of two elements is the remainder of the division by P of the product in [symbol] (p)[X] (a modulo operation). In other words, the elements of [symbol] (q) are roots of P in the polynomial ring [symbol] (p)[X].

For calculations different representations of the elements of the finite field [symbol] (q) can be used. The elements of the finite field can be represented directly by the mentioned polynomials with a degree less than d. Especially, they can be represented by the coefficients of the polynomials written in vector form. For computer implementations, very often one chooses p=2, since elements of [symbol] (2) are bits {0, 1}. Elements of the quotient field [symbol] (2^{d}) can be represented by bit strings of length d, where the bit strings are the coefficients of the polynomial being element of [symbol] (2^{d}).

Alternatively or in addition, the normal basis representation and the dual basis representation might be used for representing the elements of the quotient field [symbol] (q).

The Galois group describes the symmetry of the elements of a quotient field. Its elements are those permutations of the elements of a quotient field, such that algebraic equations are still valid for the permuted elements.

The elements of the Galois group of the extension L/K are all automorphisms of the elements of the quotient field L, which leave the elements of the base field K pointwise unchanged. Thus the coefficients of the polynomials (elements of K) are left unchanged, while the elements of L are permuted. For the special case of Galois fields over the binary field, if L= [symbol] (2^{d}), the elements of the Galois group are compositions of the square function ϕ(z)=z², which leave bits unchanged and permute bit strings, such that they stay invariant, explicitly: ϕ⁰=Id, ϕ², . . . , ϕ^{d-1}.

The cohomology groups [symbol] ^{k} can be a Galois cohomology based on the Galois group of the extension L/K of the quotient field L of the Abelian variety over a base field K. The quotient field L as well as the base field K can be the Galois fields [symbol] (q) and [symbol] (p), respectively.

The group of homomorphisms, called cochains Cₖ, mapping from the product (k times) of the Galois group Gal(L/K) of the quotient field L, over which the Abelian variety [symbol] (L) is defined, to the Abelian variety [symbol] (L) itself are defined. The cochains contain the action of the Galois group, i.e. symmetry permutations of the quotient field, in the Abelian variety.

Selecting functions might correspond to a computer-implementation of cochains.

The groups of homomorphisms for a certain k (cochains) are connected to each other via differential operators [symbol] ^{k}: C^{k} C^{k+1}. The cochains and the differential operator form a cochain complex.

Cocycles [symbol] ^{k} and coboundaries [symbol] ^{k} are elements of the group of cochains C^{k}. The cocycles [symbol] ^{k} are elements of the kernel of the differential operator [symbol] ^{k+1} and the coboundaries [symbol] ^{k} are elements of the image of the differential operator [symbol] ^{k}.

A cocycle function can be a computer-implemented function according to the mathematical object of a cocycle or an approximation thereof. A coboundary function can be a computer-implemented function according to the mathematical object of a coboundary or an approximation thereof.

The k-th cohomology group [symbol] k corresponds to the quotient group of the k-th cocycles [symbol] ^{k} modulo the group of the k-th coboundaries Bk, [symbol] ^{k}= [symbol] ^{k}= [symbol] ^{k}/ [symbol] ^{k}.

In the terminology used in this application, the kth-order cohomology group corresponds to [symbol] k.

The selecting functions might correspond to elements of the cohomology groups, in the sense that they represent the mathematical object of an element of a cohomology group (which means a map, not the group operation) or an approximation thereof.

Tracing the x and/or y-coordinate of an Abelian variety [symbol] (L), which are elements of L, over the extension field L/K yields elements of the field K. More particularly, for L= [symbol] (q) with q=2^{d} while K= [symbol] (2), one obtains a bit by tracing while the Abelian variety is defined over the larger field [symbol] (q).

The Abelian variety can also be defined over [symbol] (q^{d}), where q is not a prime. Tracing over the extension field [symbol] (q^{d})/ [symbol] (q) yields elements of q.

A ‘set’ (e.g. set of selecting functions) is meant to be non-empty. It might contain only one element.

### BRIEF DESCRIPTION OF DRAWINGS

The Figures show schematic views of:

FIG. 1: a random number generating device

FIG. 2a: adapting a model function

FIG. 2b: obtaining a selecting function by combining at least one model function

FIG. 3: various mathematical templates for the selecting functions

FIG. 4a: obtaining a selecting function based on cohomology

FIG. 4b: a recursion for obtaining starting points

FIG. 5: a processing unit running a process

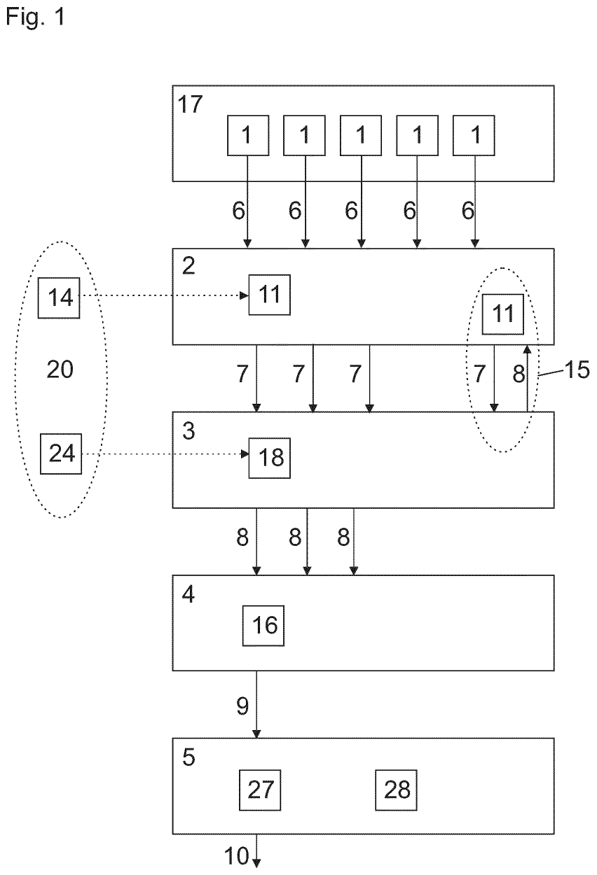

FIG. 1 shows a schematic view of a random number generating device.

At least one sensor 1, typically a plurality of sensors 1, determine at least one measured seed value 6. This can be accomplished by measuring a physical quantity such as a temperature or the noise of an electronic component, the time signature of an event such as a user input, a clock tick, a value describing network traffic and/or a value describing memory access. Typically, the sensors 1 are placed in the hardware 17 of a computer, especially in the network interface card and/or in the central processing unit. Also external sensors can be used, for instance sensors doing a quantum measurement. The at least one measured value 6 can be represented by a bit string, preferably a bit string with a length of 64 to 16000 bits. Depending on the sensors and the operating system, different measurement frequencies can be achieved. A typical value for the time interval between measurements is 1 millisecond.

If the measured seed values 6 are known to vary only slightly, a small amount of information and thus short bit strings, would be sufficient to encode the range of possible values. In such a case, the sensors 1 deliver bit strings which are partly known a priori. Thus the sensors 1 deliver less entropy. Using a measured seed value 6 as a random number directly is not efficient, since the random number would not be sufficiently random for its size. Such a situation might occur when, for instance, a measured temperature is well stabilized by cooling or little data traffic is going through the network interface card.

To overcome this problem, a plurality of measured seed values 6 can be combined to obtain a random number 10 with an increased entropy. The present invention aims to provide a method of combining different measured seed values 6, which is done by using group arithmetics on an Abelian variety 14. First the measured seed values 6 are transferred to starting points 8 on the Abelian variety 14. Second, the group operation 16 of the Abelian variety 14 is applied to the starting points 8 in order to obtain output points 9. Last, at least one random number 10 is extracted from the output points 9.

In order to enable the selection of starting points 8 on the Abelian variety 14 based on the measured seed values 6, a function unit 2 is operable to determine a set of selecting functions 7, where a selecting function 7 maps onto a point on an Abelian variety 14. A selecting function 7 can be obtained by fitting a model function 11 such that it points onto the Abelian variety 14. The selecting functions 7 thus contain the randomness from the measured seed values 6. The Abelian variety 14 can be initialized before, for instance by choosing a standard elliptic curve used for cryptographic purposes.

The selection of starting points 8 is accomplished by the selection unit 3 by evaluating the selecting functions 7. For this, typically a selection input 18 for the selecting function 7 is used. The result of this step is a set of starting points 8 on the Abelian variety 14. Preferably, the selecting functions 14 and/or the selecting input 18 is such that the resulting starting points 8 tend to be heterogeneously distributed on the Abelian variety 14. In particular, it has to be avoided, that most starting points 8 are within the same subgroup of the Abelian variety 14. The selection unit 8 thus works like a filter transforming random values (measured seed values 6) to a set of points on the Abelian variety 14 with desirable properties.

An evaluation of a selecting function 7 yielding a point on an Abelian variety 14, for instance a starting point 8, can also be used to obtain a further selecting function 7 by a recursion 15.

The selecting input 18 can be at least one element of the Galois group 24 of the field 20 over which the Abelian variety 14 is defined. It is typically represented as a matrix.

The number NF of selecting functions 7 can correspond to the number N_{SP} of starting points 8. This is particularly the case when at least one fixed selecting input 18 is used for all evaluations.

Having defined a set of starting points 8 with desirable properties, the arithmetic unit 4 generates a set of output points 9 on the Abelian variety 14 by applying the group operation 16 of the Abelian variety 14 to at least one of the elements of the set of starting points 8. By this step a set of output points 9 is obtained. Typically, the number N_{SP} of starting points 8 is larger than the number N_{OP} of output points 9. Preferably, only one output point 9 is obtained from a large number of starting points 8 originating from a large number NM of measured seed values 6. Large in this context might mean from 100 to 1000, from 1000 to 10000 or from 10000 to 100000. In this step, the randomness of the starting points 8 is condensed into a smaller number of output points 9.

In typical applications, it is desirable that the random number generating device outputs a number, not a point. To this end, the extraction unit 5 extracts at least one random number 10 from the set of output points 8. In this step a further summing operation, for instance a trace function 27, might be applied. By the trace function 27 a value of a larger extension field, for instance a bit string of length d where d>1, can be mapped to the value of a smaller base field, for instance a bit.

The trace function 27 might be applied to one specific coordinate of the output point 9 only. Also, an integerization function 28 might be applied when working with float numbers.

The result, a random number 10, can be used for further applications. For instance, it can be used for simulations, as a seed for an artificial intelligence system and so forth.

The function unit 2 and the corresponding step in the computer-implemented method is responsible for delivering selecting functions 7 with desirable properties for random number generation. Typically, the at least one selecting function 7 is a nonlinear function of a selecting input 18, wherein the selecting input 18 is preferably represented by a matrix. Also, the selecting function 7 is typically continuous.

The model function 11 might for instance be chosen as \tilde{x}(A)=αAⁿx+b, which is non-linear in the selecting input 18 represented as matrix A with some integer exponent n. a and b are two parameters. The parameter x is a vector and can correspond to a point and/or a coordinate of a point on the Abelian variety 14. The elements of the vector x (and/or the parameters a and b) are partially based on the at least one measured seed value 6 and partially chosen such that the selecting function 7 maps onto the Abelian variety 14. Other examples of non-linear model functions 11 are \tilde{x}(A)=sin(A)·x or \tilde{x}(A)=α·log(A)·x+b.

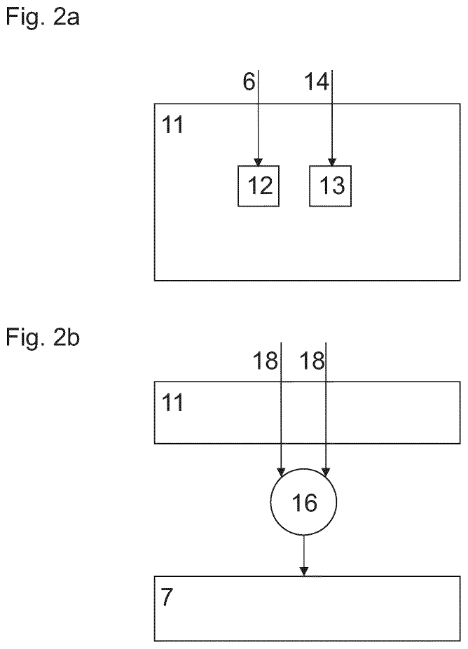

FIGS. 2a and 2b show a schematic view of a method for obtaining a selecting function 7. In FIG. 2a a model function 11 with at least one first parameter 12 and at least one second parameter 13 is chosen. In a first step, at least one first parameter 12 of the model function 11 based on the at least one measured seed value 6 is selected. By this, the randomness is inserted into the resulting selecting function 7. In a second step, the at least one second parameter 13 of the model function 11 is chosen such that the model function 11 maps to the Abelian variety 14. This corresponds to a fitting procedure and can be accomplished with standard methods from linear algebra, such as using Gröbner bases.

In a final step, the so-fitted model function 11 might be identified with the selecting function 7. Alternatively, the selecting function 7 is obtained by combining the fitted model function 11 evaluated at different selecting inputs 18 with the group operation 16 and/or other operations, which is shown in FIG. 2b. As a basic example, one might use a combination C(A, B)=\tilde{x}(A)+\tilde{x}(B) as selecting function 7, where the two selecting inputs A and B might be matrices. In a preferred embodiment, more specific combinations based on cohomology theory are chosen, as explained in the following.

The choice of the model function 11 and their combination is of course crucial for the performance of the resulting selecting functions 7, since the function 7 needs to map onto starting points 8 with good properties for random number generation.

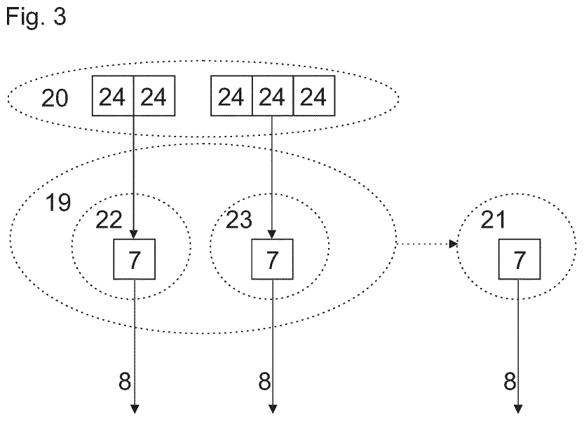

In a preferred embodiment of the invention, cohomology theory is used in order to obtain suitable selecting functions 7. FIG. 3 shows different mathematical templates from cohomology theory for the selecting function 7. In this vein, the selecting functions 7 can correspond to elements of a cohomology group 19 of the Abelian variety 14, preferably wherein the cohomology group 13 is defined by methods from Galois cohomology based on the field 20 over which the Abelian variety 14 is defined. Alternatively or additionally, the selecting functions 7 can correspond to elements of a structure 21 derived from a cohomology group 19 of the Abelian variety 14, preferably wherein the structure 21 derived from a cohomology group 19 of the Abelian variety 14 is defined from duality and/or bilinear forms.

The selecting functions 7 can correspond to elements of a first-order cohomology group 22, wherein a selecting function 7 preferably takes at least one, preferably two, element(s) of the Galois group 24 of the field 20 on which the Abelian variety 14 is defined as selecting input 18. The selecting functions 7 can also correspond to a elements of a second-order cohomology group 23, wherein a selecting function 7 preferably takes three elements of the Galois group 24 of the field 20 on which the Abelian variety 14 is defined as input. Also higher-order cohomology groups can be used to define selecting functions 7.

The applicant found statistical evidence, that the use of selecting functions 7, which are computer-implementations of elements of cohomology groups 22 or derived structures 21 thereof deliver especially heterogeneous starting points 8. Moreover, cohomology theory provides a systematic hierarchy of complex structures, which can be used as a template for the selecting functions 7. For instance, first-order cohomology can be used if efficiency is more important to the user, and higher-order cohomology can be used, if more heterogeneous starting points 8, and thus more randomness is desired.

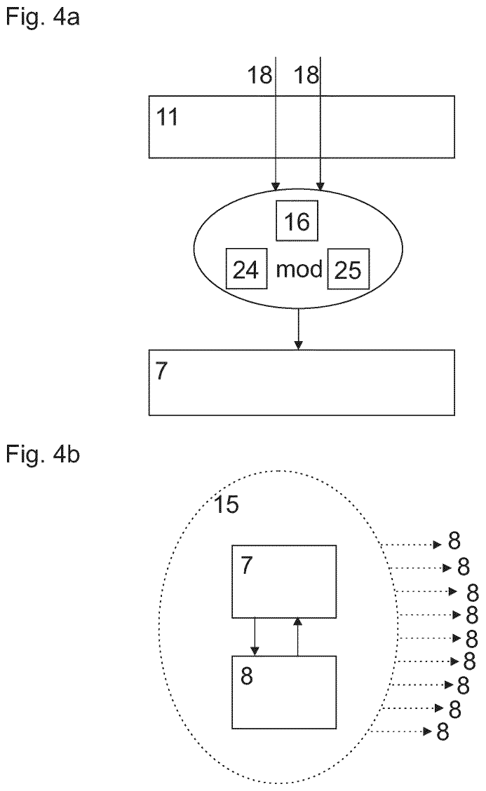

The FIGS. 4a and 4b show a schematic illustration of how selecting functions 7 corresponding to elements of cohomology groups 19 can be calculated.

As in FIG. 2, first at least one first parameter 12 of a model function 11 based on the at least one measured seed value 6 is calculated. Second, at least one second parameter 13 of the model function 11 is selected such that the model function 11 maps a selecting input 18, preferably in form of a matrix, to the Abelian variety 14.

In a third step shown in FIG. 4a, the selecting function 7 is obtained by combining the so-fitted model function 11 evaluated at different selecting inputs 18 such that it corresponds to an element of the cohomology group 19. Preferably, the combination comprises a cocycle function 25 modulo a coboundary function 26 and/or the application of the group operation 16.

In order to obtain a selecting function 7 which corresponds to an element of a first-order cohomology group 22, the selecting function 7 can be combination of a fitted model function 11 given by C(A, B)=[A·\tilde{x}(B)+\tilde{x}(A)]mod[A·P−I·P]. Hereby, \tilde{x} are fitted model functions 11 pointing onto the Abelian variety. A and B are selecting inputs 18, preferably elements of the Galois group 24 of the field 20 over which the Abelian variety 14 is defined and can be represented by matrices. P is a point on the Abelian variety 14 and can be represented by a vector. The point P can be chosen by trial and error such that the starting points 8 or the sequence of starting points 8 are/is sufficiently random. [symbol] is the identity matrix. The part before the modulo operation corresponds to a cocycle function 25, the part after the modulo operation corresponds to a coboundary function 26. The addition+and the subtraction−are group operations 16 on the Abelian variety 14.

By this method, a selecting function 7 which corresponds to an element of a cohomology group 19 can be obtained. Since the model function 11 is based on the at least one measured seed value 6, the selecting function 7 contains the entropy of the at least one sensor 1.

For a selecting function 7 which corresponds to an element of a second-order cohomology group 23, the selecting function 7 can also be combined from cocycle function 25 modulo a coboundary function 26. Here, three selecting inputs 18 represented by elements of a Galois group 24 are used, which are preferably chosen based on the at least one measured seed value 6. Instead of fitting the model function 11 (with methods from linear algebra), a trial and error method can be applied to find model functions 11 which point onto the Abelian variety 14.

For instance the cocycle function 25 might have the form C_{Z}(A, B, C)=\tilde{x}(A, B·C)−\tilde{x}(A·B, C)+A·\tilde{x}(B, A) and the coboundary function 26 might have the form C_{B}(A, B)=\tilde{y}(A)−\tilde{y}(A·B)+A·\tilde{y}(B), whereby A, B and C are selecting inputs 18, especially elements of a Galois group 24 represented by a matrix. The model functions \tilde{x} and \tilde{y} pointing onto the Abelian variety 14 can for instance be obtained by a trial and error method. The selecting function 7 might then be obtained by a modulo operation C_{Z}(A, B, C) mod C_{B}(A, B). An evaluated selecting function 7 yields a starting point 8.

Further selecting functions 7 and starting points 8 can be obtained efficiently by a recursion 15 as shown in FIG. 4b. In a first step, a selecting function 7 is evaluated with at least one selecting input 18 in order to obtain a point on the Abelian variety 14. This point can be used as a starting point 8. In a second step, at least one parameter of the selecting function 7 based on the previously obtained point on the Abelian variety 14 is changed. These steps are repeated with the updated selecting function 7. By this method, a starting point 8 is obtained in each step.

The selecting function 7 might comprise a point on the Abelian variety 14 as a parameter and this parameter can be substituted with the point on the Abelian variety obtained in the preceding step of the recursion 15.

Thereby, parameters of the model function 11 can be changed based on the point on the Abelian variety 14 obtained in the preceding step of the recursion 15.

For instance, in a model function 11 of the form \tilde{x}(A)=αAⁿx+b, the vector x might be substituted with the point on the Abelian variety 14 obtained in the preceding step of the recursion 15. The updated model function 11 can be combined in order to obtain an updated selecting function 7.

For first-order cohomology, the updated model function \tilde{x}′ can be combined in order to obtain an updated selecting function C′(A, B)=[A·\tilde{x}′(B)+\tilde{x}′(A)]mod[A·P−− [symbol] ·P]. The selecting inputs 12 (A and B) can remain fixed during the recursion 15. Also, the coboundary functions 26 can remain fixed during the recursion 15.

A recursion 15 can be analogously applied to the above-mentioned formulas for second-order cohomology or higher order cohomology.

With this method, a plurality of selection functions 7 can be obtained, which are all elements of a cohomology group 19. The selection functions 7 are evaluated in each step yielding a set of starting points 8 during the recursion 15.

The recursion 15 is repeated for a number of iterations. The number of iterations can be fixed and/or based on at least one measured seed value 6 and/or based on at least one starting point 8, which preferably stems from the recursion 15 itself.

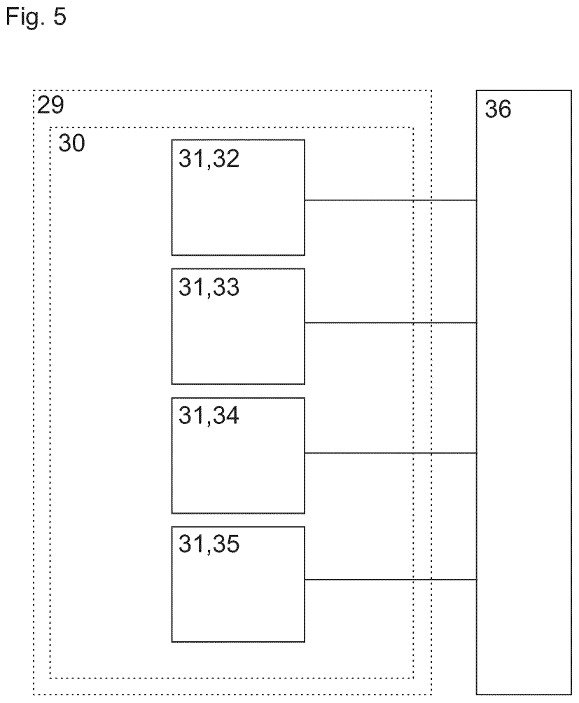

FIG. 5 shows at least one processing unit 29 running at least one process 30, wherein a process 30 comprises at least one thread 31, wherein at least one of the steps of the computer-implemented method is run by a dedicated thread, wherein the dedicated threads interact via asynchronous parallelization, preferably by using semaphors and/or a shared memory 36 which can be accessed by at least two dedicated threads. The dedicated threads comprise
a first dedicated thread 32, which calculates cocycle functions 25, and/or
a second dedicated thread 33, which calculates functions corresponding to a cocycle modulo a coboundary, and/or
a third dedicated thread 34, which evaluates the selecting functions 7, and/or
a fourth dedicated thread 35, which adds starting points 8 on the Abelian variety 14.

The function unit 2, the selection unit 3, the arithmetic unit 4 and the extraction unit 5 might be logical units and/or physical units. Each of the units might be run on a dedicated thread, similar to the illustration in FIG. 5.

### REFERENCE SIGNS LIST

1 sensor
2 function unit
3 selection unit
4 arithmetic unit
extraction unit
6 measured seed value
7 selecting function
8 starting point
9 output point
10 random number
11 model function
12 first parameter
13 second parameter
14 Abelian variety
15 recursion
16 group operation
17 hardware of a computer
18 selecting input
19 cohomology group
20 field
21 structure derived from a cohomology group
22 first-order cohomology group
23 second-order cohomology group
24 element of the Galois group
25 cocycle function
26 coboundary function
27 trace function
28 integerization function
29 processing unit
30 process
31 thread
32 first dedicated thread
33 second dedicated thread
34 third dedicated thread
35 fourth dedicated thread
36 shared memory

1. A computer-implemented method for generating at least one random number, comprising:
determining at least one measured seed value with a sensor;
based on the at least one measured seed value, determining a set of selecting functions, where a selecting function maps onto a point on an Abelian variety;
evaluating the selecting functions in order to obtain a set of starting points on the Abelian variety;
generating a set of output points on the Abelian variety by applying the group operation of the Abelian variety to at least one of the elements of the set of starting points; and
extracting at least one random number from the set of output points.

2. The computer-implemented method of claim 1, wherein the at least one measured seed value;
is physical quantity such as a temperature or the noise of an electronic component, the time signature of an event such as a user input, a clock tick, a value describing network traffic and/or a value describing memory access, and/or
is measured by the sensor placed in the hardware of the computer, especially in the network interface card and/or in the central processing unit, and/or
is represented by a bit string, preferably a bit string with a length of 64 to 16000 bits.

3. The computer-implemented method of claim 1, wherein the at least one selecting function is a continuous and/or non-linear function of a selecting input, wherein it is preferred that the selecting input is represented by a matrix.

4. The computer-implemented method of claim 1, wherein at least one selecting function is obtained by choosing a model function with at least one first parameter and at least one second parameter, wherein the computer-implemented method further comprises:
selecting at least one first parameter of a model function based on the at least one measured seed value,
selecting at least one second parameter of the model function such that the model function maps a selecting input, preferably rep-resented by a matrix, to the Abelian variety, and
obtaining the selecting function by identifying it with the so-fitted model function and/or by combining the so-fitted model function evaluated with at least one, preferably at least two different, selecting input(s).

5. The computer-implemented method of claim 1, wherein:
the selecting functions are elements of at least one cohomology group of the Abelian variety, preferably wherein the at least one cohomology group is defined by methods from Galois cohomology based on the field over which the Abelian variety is defined, and/or
elements of a structure derived from at least one cohomology group of the Abelian variety, preferably wherein the structure derived from the at least one cohomology group of the Abelian variety is defined from duality and/or bilinear forms.

6. The computer-implemented method of claim 5, wherein the at least one cohomology group is;
a first-order cohomology group, wherein a selecting function prefer-ably takes at least one, preferably two, element (s) of the Galois group of the field on which the Abelian variety is defined as input, and/or
a second-order cohomology group, wherein a selecting function preferably takes at least one, preferably three, element (s) of the Galois group of the field on which the Abelian variety is defined as input, and/or
a cohomology group with an order higher than two.

7. The computer-implemented method of claim 5, wherein at least one selecting function is obtained by choosing a model function with at least one first parameter and at least one second parameter, wherein the computer-implemented method further comprises:
selecting at least one first parameter of a model function based on the at least one measured seed value,
selecting at least one second parameter of the model function such that the model function maps a selecting input, preferably represented by a matrix, to the Abelian variety, and
obtaining the selecting function by combining the so-fitted model function evaluated at different selecting inputs such that it corresponds to an element of the at least one cohomology group, preferably whereby the combination comprises a part corresponding to a cocycle function modulo a part corresponding to a coboundary function.

8. The computer-implemented method of claim 1, wherein a starting point is generated by evaluating a selecting function with a selecting input, wherein the selecting input is preferably;
an element of the Galois group of the field over which the Abelian variety is defined and/or,
represented as a matrix.

9. The computer-implemented method of claim 1, wherein a recursion is applied in order to obtain a set of starting points, wherein the recursion preferably includes:
evaluating the selecting function with at least one selecting input in order to obtain a point on the Abelian variety,
changing at least one parameter of the selecting function based on the previously obtained point on the Abelian variety, and
repeating the previous steps with the updated selecting function and/or wherein the selecting function preferably comprises a point on the Abelian variety as a parameter and wherein this parameter is substituted with the point on the Abelian variety obtained in the preceding step of the recursion.

10. The computer-implemented method of claim 1, wherein a set of output points is generated by:
calculating the sum of the elements of at least one subset of the set of starting points with the group operation to obtain one output point per subset, wherein preferably the sum of all elements of the set of starting points is calculated with the group operation to obtain one output point, and/or
adding at least one element of the set of starting points to itself, preferably by applying a linear congruential scheme, a power generator scheme or a Naor-Reingold scheme.

11. The computer-implemented method of claim 1, wherein the at least one random number is extracted from the set of output points by:
taking a coordinate of at least one output point, and/or
applying a trace function, where preferably a trace function is applied to a coordinate of at least one output point, and/or
applying an integerization function, where the integerization function has an integer output, where the integerization function is in particular a floor function or a ceiling function.

12. The computer-implemented method of claim 1, wherein the computer comprises at least one processing unit running at least one process, wherein a process comprises at least one thread, wherein at least one of the steps of the computer-implemented method is run by a dedicated thread, wherein preferably:
a first dedicated thread calculates cocycle functions, and/or a second dedicated thread calculates functions corresponding to a cocycle modulo a coboundary, and/or
a third dedicated thread evaluates the selecting functions, and/or
a fourth dedicated thread adds starting points on the Abelian variety, and/or wherein the dedicated threads interact via asynchronous parallelization, preferably by using semaphors and/or a shared memory which can be accessed by at least two dedicated threads.

13. A random number generating device, comprising
a sensor,
a function unit,
a selection unit,
an arithmetic unit,
an extraction unit,
wherein:
the sensor is operable to determine at least one measured seed value,
the function unit is operable to determine a set of selecting functions based on the at least one measured seed value, where a selecting function maps onto a point on an Abelian variety,
the selection unit is operable to evaluate the selecting functions in order to obtain a set of starting points on the Abelian variety,
the arithmetic unit is operable to generate a set of output points on the Abelian variety by applying the group operation of the Abelian variety to at least one of the elements of the set of starting points, and
the extraction unit is operable to extract at least one random number from the set of output points.

14. A random number generating device, operable to carry out the computer-implementable method according to claim 1.

15. A computer program which, when executed by a random number generating device, causes the random number generating device to carry out the computer-implementable method according to claim 1.
